(19) United States
(12) Patent Application Publication
(10) Pub. No.: US 2017/0040940 A1
(43) Pub. Date: Feb. 9, 2017

(54) Integrated Solar Energy Curtain Wall System

(71) Applicant: Advanced Building Systems, Inc., Wilmington, DE (US)

(72) Inventor: Raymond M.L. Ting, Pittsburgh, PA (US)

(21) Appl. No.: 15/212,878

(22) Filed: Jul. 18, 2016

Related U.S. Application Data
(60) Provisional application No. 62/201,920, filed on Aug. 6, 2015.

(51) Int. Cl. H02S 40/36; E04B 2/96

(52) U.S. Cl. CPC H02S 40/36; E04B 2/965; E04B 2/967

(57) ABSTRACT

An airloop curtain wall system with solar energy units integrated into the curtain wall panels is disclosed. The disclosed system provides electrical connections between adjacent solar energy curtain wall panels without compromising the curtain wall watertightness performance and permits easy replacement of solar energy units from the building interior.

### CROSS-REFERENCE TO RELATED APPLICATIONS

This application claims the benefit under 35 U.S.C. §119(e) of the earlier filing date of U.S. Provisional Patent Application No. 62/201,920 filed on Aug. 6, 2015.

### BACKGROUND OF THE INVENTION

1. Field of Invention

This invention relates to an exterior curtain wall design with the application of solar energy panels in selected areas of the curtain wall.

2. Background of Invention

An exterior curtain wall is formed by multiple wall units joined and sealed between two adjacent wall units in both the horizontal and vertical directions. The major functions of an exterior wall include the aesthetic design provided by the project architect and the interior environmental protection design provided by the exterior wall system designer or supplier. It is well recognized in the industry that wind load resistance, water-tightness performance, and thermal insulation are three of the most important functions of the interior environmental protection design. To apply solar energy panels on a curtain wall system, the following additional design considerations should be considered.

First, the location of solar energy panels should be selected for sun exposure, such as wall elevations receiving maximum sun exposure and with maximum height from the ground.

Second, a wiring method must be used to bring the electrical power generated by the solar energy panels into the interior of the building. In order to fulfill this functional requirement, the wiring must penetrate through the curtain wall. The wiring penetration locations create potential water leakage problems. Therefore, it is advantageous to minimize the number of wiring penetration locations. To accomplish this goal, solar wall panels in today's market have the following features: (1) solar wall panels in a horizontal row; (2) shop-assembled positive and negative electrical connectors in each unit for easy snap-on field connection to the adjacent units in a series configuration; (3) ultimate wiring penetration at a location near the wall corner or at a terminating wall jamb; (4) permanent aesthetic and weather protective cover for the exposed wiring and connectors.

Third, a curtain wall with solar panels must be designed to permit replacement of damaged and/or dysfunctional solar energy units. Replacing an individual solar energy unit is a functional requirement for maintenance. There are two options for fulfilling this functional requirement.

One option is integrating the solar energy units into the curtain wall system. This option minimizes aesthetic impact caused by the wiring system. However, technical difficulties of integrating a solar energy unit into a curtain wall system include: (1) To bring the wiring out for either exterior or interior electrical connection in series between adjacent curtain wall units, penetrations on certain components of each wall unit are inevitable. Thus, the risk of water leakage is high due to the requirement of a perfect field-executed seal on the penetration hole. (2) If the electrical connectors are hidden inside the curtain wall system during erection, then it is extremely difficult to access the connectors to disconnect an old solar energy unit and connect a new solar energy unit if the old unit requires replacement. (3) If the electrical connectors are exposed either exteriorly or interiorly, the aesthetic features of the curtain wall system will be compromised by an additional wiring system cover.

The second option is out-hanging the solar energy panel system on the erected curtain wall. Advantages of this option include: (1) The risk of water leakage attributable to the addition of solar energy panels is limited to the final wiring penetration locations, typically at a wall corner or at a terminating wall jamb. (2) There are fewer technical problems for replacing an individual solar energy panel. Disadvantages of this option include: (1) The exterior aesthetic feature of the curtain wall system is compromised at the solar energy panel area. (2) Significant additional cost. (3) Exterior access equipment is required for replacing an individual solar energy panel. (4) In a high-rise building with vision glass bands sandwiched between two solar energy panel bands in the spandrel area, out-hanging solar energy panels cause technical difficulties for exterior window washing systems.

Almost all existing solar energy wall systems use the out-hanging option, but a curtain wall system with integrated solar energy units without additional risk of water leakage is desirable.

### BRIEF SUMMARY OF THE INVENTION

Preferred embodiments of the present invention provide a solar energy wall panel design having the one or more of the following features: (1) ability to integrate any commercially available solar energy unit into a curtain wall panel or unit without additional risk of water leakage; (2) compatibility with regular non-solar panels or units in all curtain wall performance functions; (3) no need for an additional aesthetic wiring cover either indoors or outdoors; (3) ability to easily replace an individual solar energy unit from the building interior; (4) significant cost reduction compared to current out-hanging solar energy wall systems.

In preferred embodiments of the present invention, a solar energy panel is integrated into an airloop curtain wall unit. In an airloop system (U.S. Pat. Nos. 5,598,671 and 7,134,247, which are incorporated by reference), the problem of water leakage in a curtain wall system is solved by creating perimeter inner and outer airloops to isolate the air seal from the water seal. The outer airloop around each individual panel is weather protected by three layers of barriers, namely a water repelling barrier, a water seal line, and an air seal line. The water repelling barrier will repel most of the wind driven rain water while allowing exterior air to enter the wall panel joints to pressure equalize all wall joint cavities. The space between the water repelling barrier and the water seal line is a wet outer airloop segment with an instantaneous water drainage mechanism. The space between the water seal line and the air seal line is a dry outer airloop segment.

Due to the pressure equalization of all wall joint cavities, an airloop system can tolerate a high degree of imperfection in both water seal and air seal lines without causing water leakage. Thus, electrical wiring penetrations in the curtain wall panel frame required for integration of solar energy panels may be made between pressure-equalized spaces without increasing the risk of water leakage.

In preferred embodiments, a solar energy panel is held in an airloop curtain wall panel frame. The frame members form pressure-equalized airloops around the perimeter of the solar energy panel. When the curtain wall is erected, solar energy panels in adjacent curtain wall units may be electrically connected in series via a wire passing through a hole in the head frame member of each curtain wall unit and through the mullion between the curtain wall units.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows an isometric view of a typical insulated glass solar energy unit that may be incorporated into a preferred wall panel of the present invention.

FIG. 2 shows an isometric view of a single glass solar energy unit that may be incorporated into a preferred wall panel of the present invention.

FIG. 3 shows an isometric back view of a preferred shop-assembled and ready to be erected airloop panel of the present invention incorporating the insulated glass solar energy unit of FIG. 1.

FIG. 4 shows an isometric back view of a preferred shop-assembled and ready to be erected airloop panel of the present invention incorporating the single glass solar energy unit of FIG. 2.

FIG. 5A shows an isometric fragmental view of a preferred shop pre-wired and ready to be erected airloop mullion of the present invention for field wire connection in series between two adjacent solar panels.

FIG. 5B shows a cut away isometric fragmental view of the mullion of FIG. 5A.

FIG. 6A shows an isometric fragmental view of a shop pre-wired and ready to be erected airloop mullion of the present invention for field wire connection from the end of a row of solar panels to a lower starting row of solar panels or to the wiring system leading to the power distribution center of the building.

FIG. 6B shows a cut away isometric fragmental view of the mullion of FIG. 6A.

FIG. 7 shows a fragmental isometric view of two adjacent erected solar panels with the wiring connection between the two adjacent panels.

FIG. 8 shows a fragmental isometric view of a shop-fabricated head glazing bead with notches at the locations of the wire connectors.

FIG. 9 shows as an example a partial interior view of an installed wall within an area with solar panels, showing no exposed wiring and a preferred path of a concealed wiring system connected in series.

FIG. 10 shows a fragmental cross-section view taken along line 10-10 of FIG. 9 at the horizontal joint between a regular, non-solar energy panel, and an insulated glass solar energy panel.

FIG. 11 shows a fragmental cross-section view taken along line 11-11 of FIG. 9 at the horizontal joint between adjacent, single glass solar energy panels.

### DETAILED DESCRIPTION OF THE INVENTION

Reference will now be made in detail to the preferred embodiments of the present invention, examples of which are illustrated in the accompanying drawings. For the purpose of clarity, in the following descriptions, the required protective sleeves for electrical wiring at the hole locations on the aluminum extrusions are not shown in the drawings.

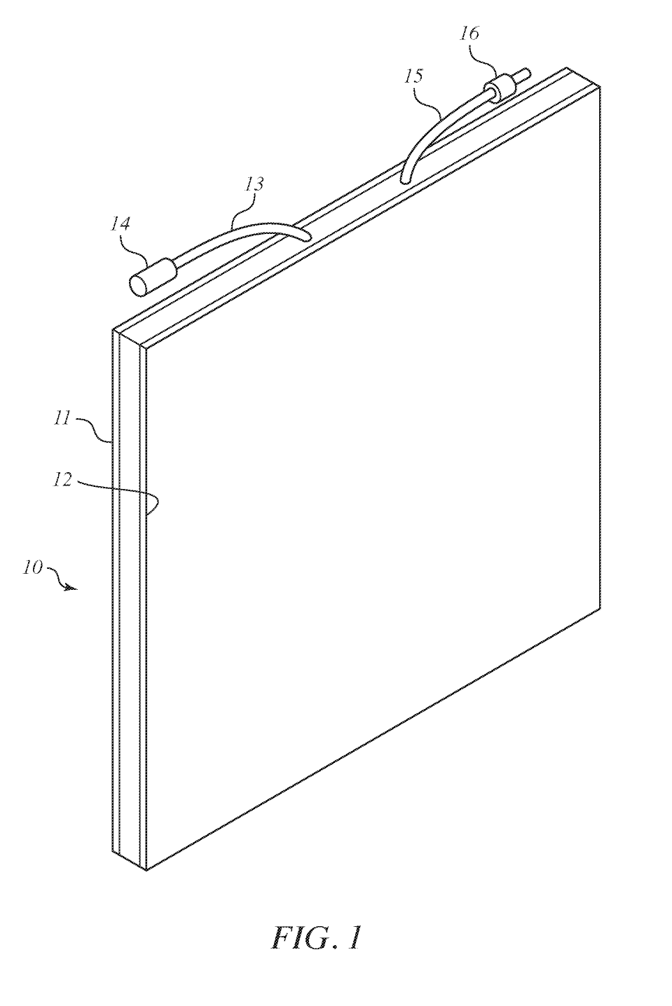

FIG. 1 shows an isometric view of a typical insulated glass solar energy unit 10 with an exterior glass pane 11 and an interior glass pane 12. The wire chase (not shown) is sandwiched between the two glass panes with a positive outlet wire 13, a shop-installed positive connector 14, a negative outlet wire 15, and a shop-installed negative connector 16.

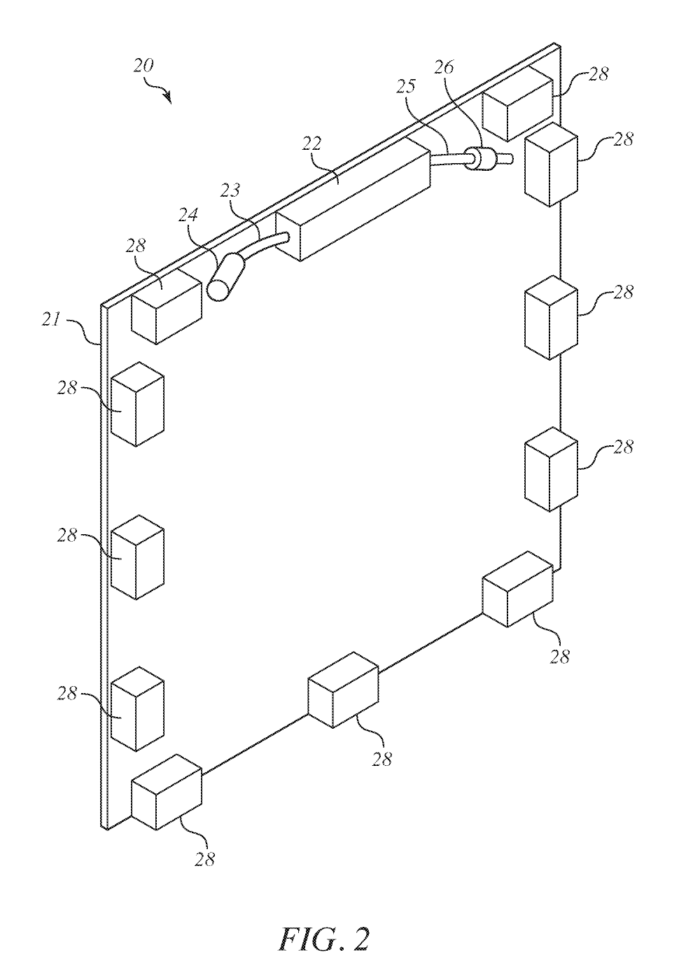

FIG. 2 shows an isometric interior view of a typical single glass solar energy unit 20 with a single glass pane 21. Coming out of the wire chase 22 are a positive outlet wire 23, a shop-installed positive connector 24, a negative outlet wire 25, and a shop-installed negative connector 26. The positive connector 24 and the negative connector 26 may be made as integral parts of the wire chase 22, eliminating the outlet wires 23 and 25. For adaptation into the present invention, spaced apart structural spacer blocks 28 having the same depth of the wire chase 22 are included on the perimeter of the glass pane 21. The structural spacer blocks 28 may be shop-glued to glass pane 21. The required number of spacer blocks 28 depends on the size of the glass pane 21.

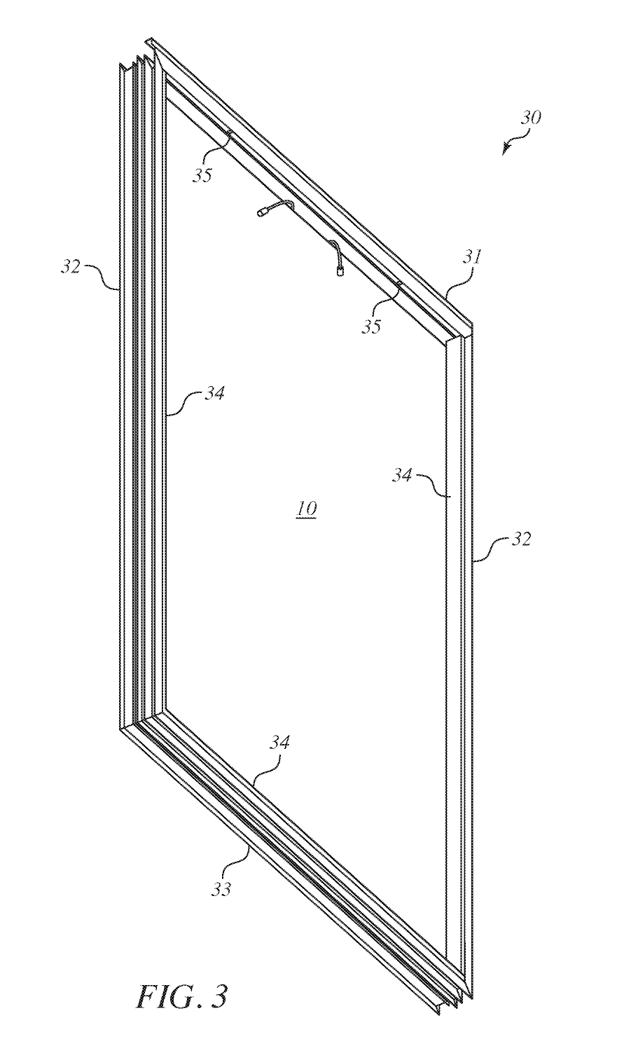

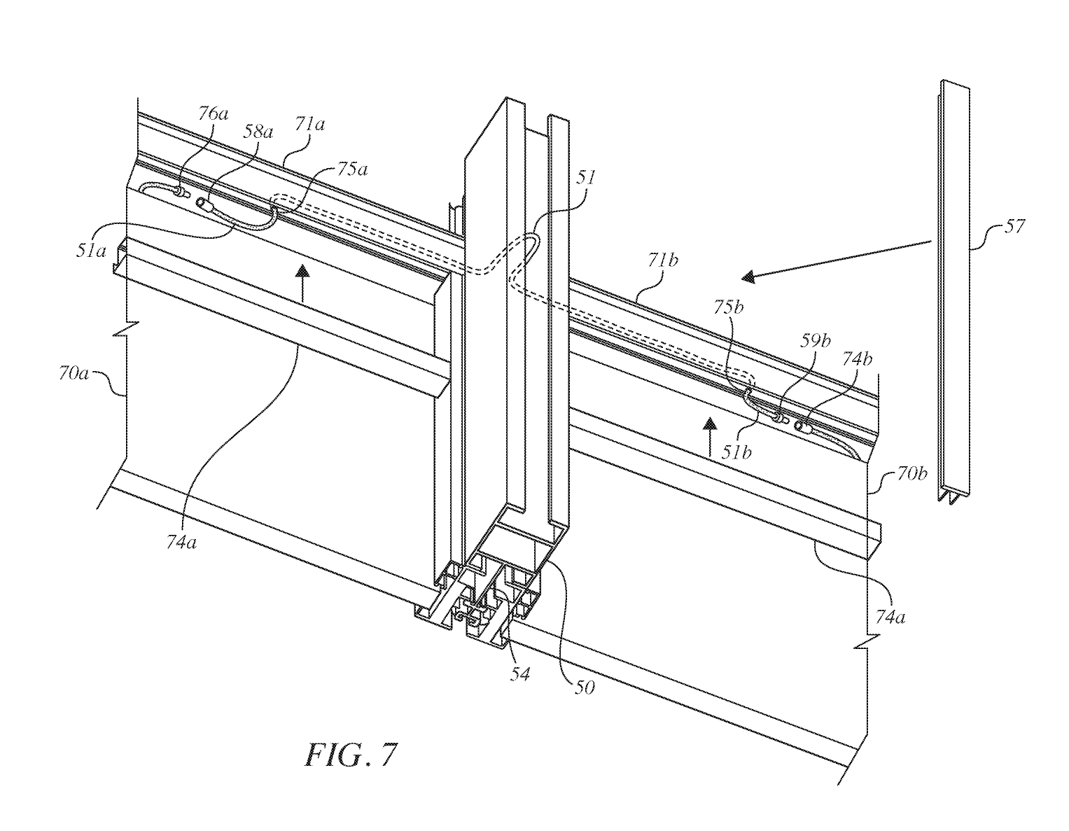

FIG. 3 shows an isometric interior view (looking from an angle to show the underside of the head frame member 31) of a typical shop-assembled and ready to be erected airloop panel 30 of the present invention incorporating the insulated glass solar energy unit 10 depicted in FIG. 1. The shop-assembled airloop panel perimeter frame consists of a head frame member 31, two jamb frame members 32, and a sill frame member 33. The solar energy unit 10 is structurally secured inside the panel frame on three sides (sill and two side jambs) by demountable glazing beads 34. A glazing bead for the head frame member is added during panel erection, as described below in the description accompanying FIG. 7. Two wiring holes 35 are provided on the head frame member 31.

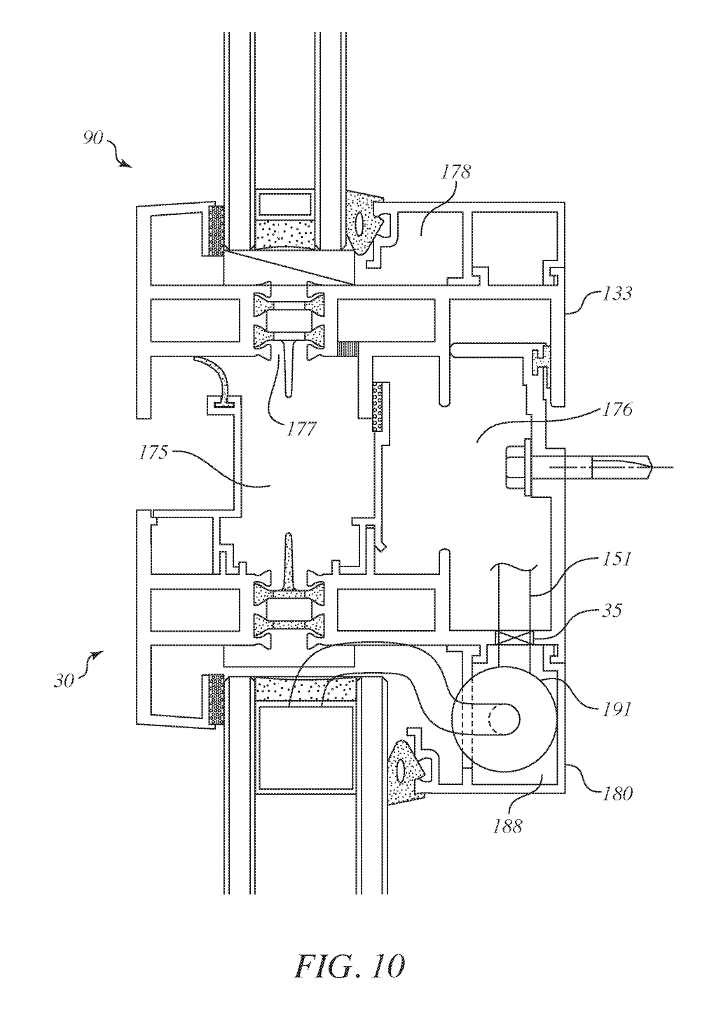

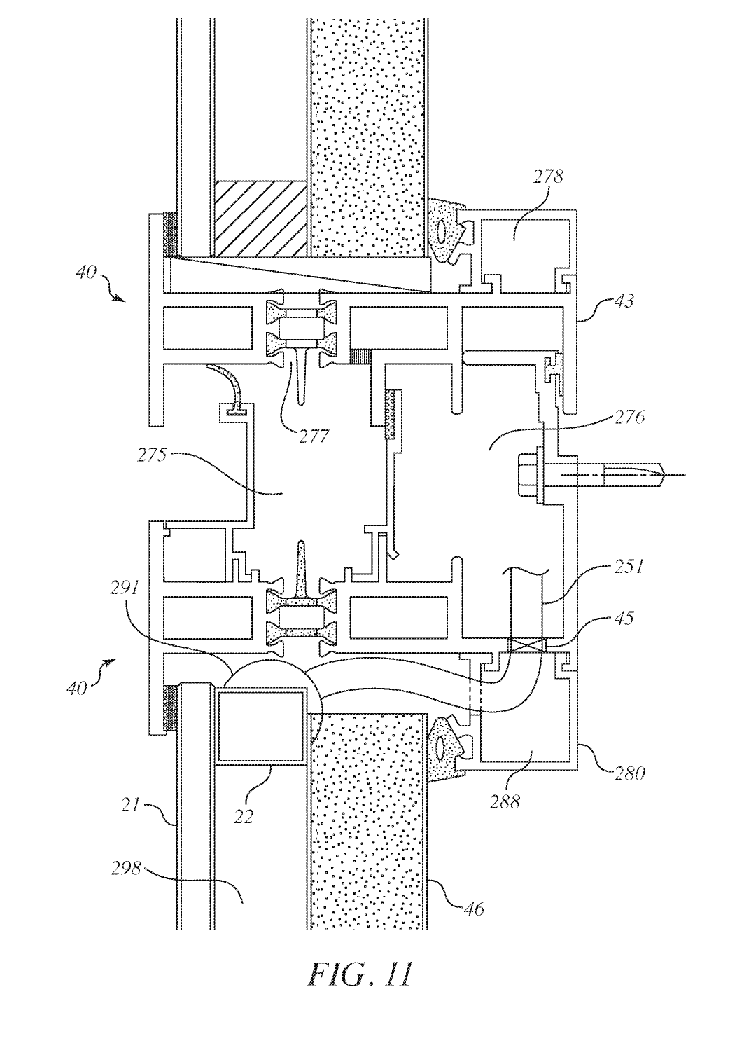

As one of ordinary skill in the art would recognize as described in U.S. Pat. Nos. 5,598,671 and 7,134,247, an assembled airloop panel has air spaces substantially forming a loop around and near the panel facing element (e.g., a solar energy unit) and generally within the panel perimeter frame. The airloops are connected to exterior air to provide pressure equalization that prevents water infiltration. Additional pressure-equalized spaces are formed in the joints between adjacent panels, as shown in FIGS. 10 and 11.

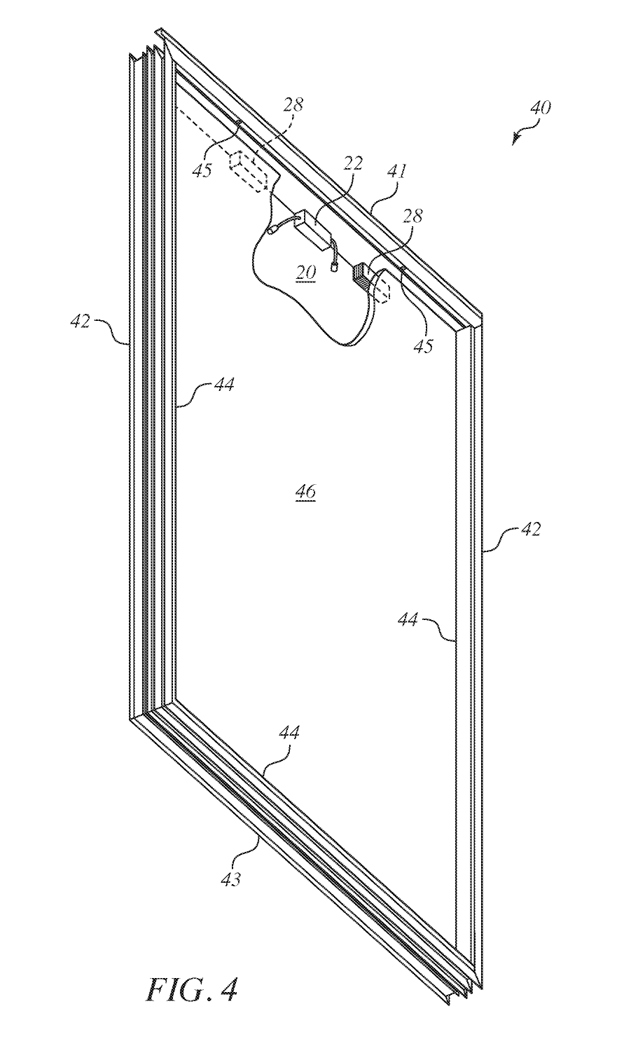

FIG. 4 shows an isometric interior view (looking from an angle to show the underside of the head frame member 41) of a typical shop-assembled and ready to be erected airloop panel 40 of the present invention incorporating the single glass solar energy unit 20 depicted in FIG. 2. The shop-assembled airloop panel perimeter frame consists of a head frame member 41, two jamb frame members 42, and a sill frame member 43. A structural panel 46 is placed behind the solar energy unit 20, against the spacer blocks 28 and wire chase 22. The solar energy unit 20 and the structural panel 46 are structurally secured inside the panel frame on three sides (sill and two side jambs) by demountable glazing beads 44. Two wiring holes 45 are provided on the head frame member 41. For illustration purposes, a portion of the structural panel 46 is cut away in FIG. 4 to show the solar energy unit 20 with the wire chase 22 and the spacer blocks 28.

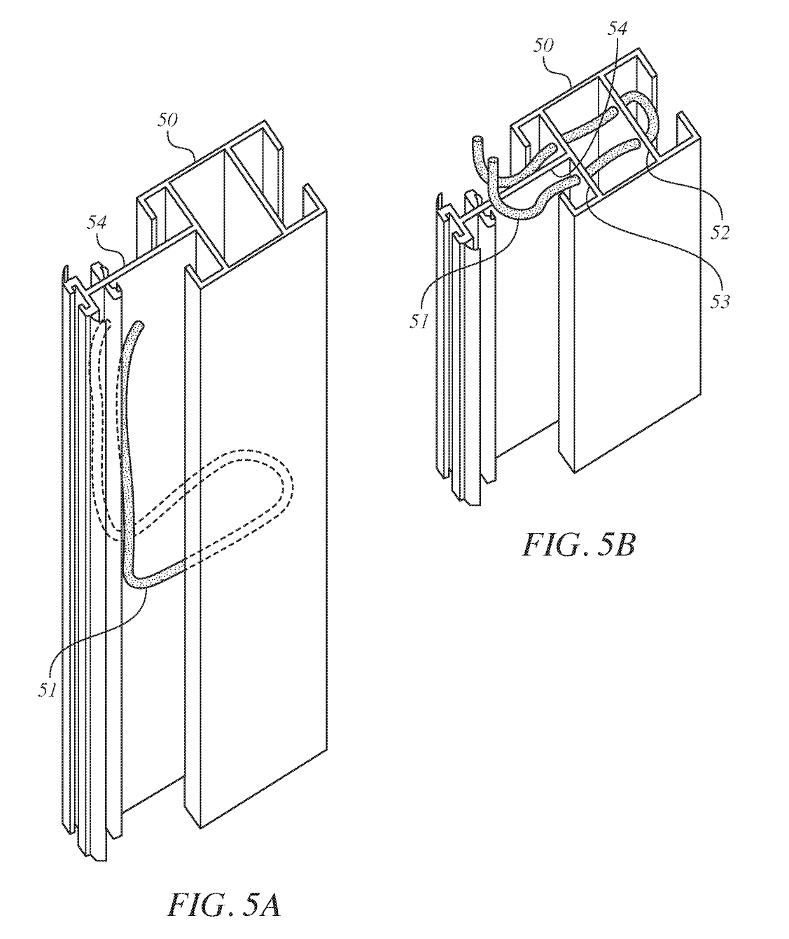

FIG. 5A shows an isometric fragmental view of a typical shop pre-wired and ready to be erected airloop mullion 50 of the present invention. A mullion wire 51 for connecting the solar energy panels to be installed on each side of the mullion 50, is shop wired inside the mullion 50 with the loose ends turning upwardly on both sides of the mullion web 54. The length of the mullion wire 51 depends on the distance required for field wire connections to the installed solar energy panels on each side of the mullion 50.

FIG. 5B is a cut away view of the mullion 50 near the wire loop inside the mullion 50. The mullion wire 51 penetrates through two mullion walls 52 and 53 on each side of the mullion web 54 and loops around at the mullion wall 52. The locations of the wiring holes are preferably selected to be slightly lower than the panel screw location of the solar panel to be field connected. At this location, there is limited relative movement between the mullion 50 and the head panel frame 31 (shown in FIG. 3) or 41 (shown in FIG. 4) in the event of panel drift caused by inter-floor story drift in a seismic event. Therefore, there is no concern about the installed mullion wire 51 being pinched by the motion of panel drift.

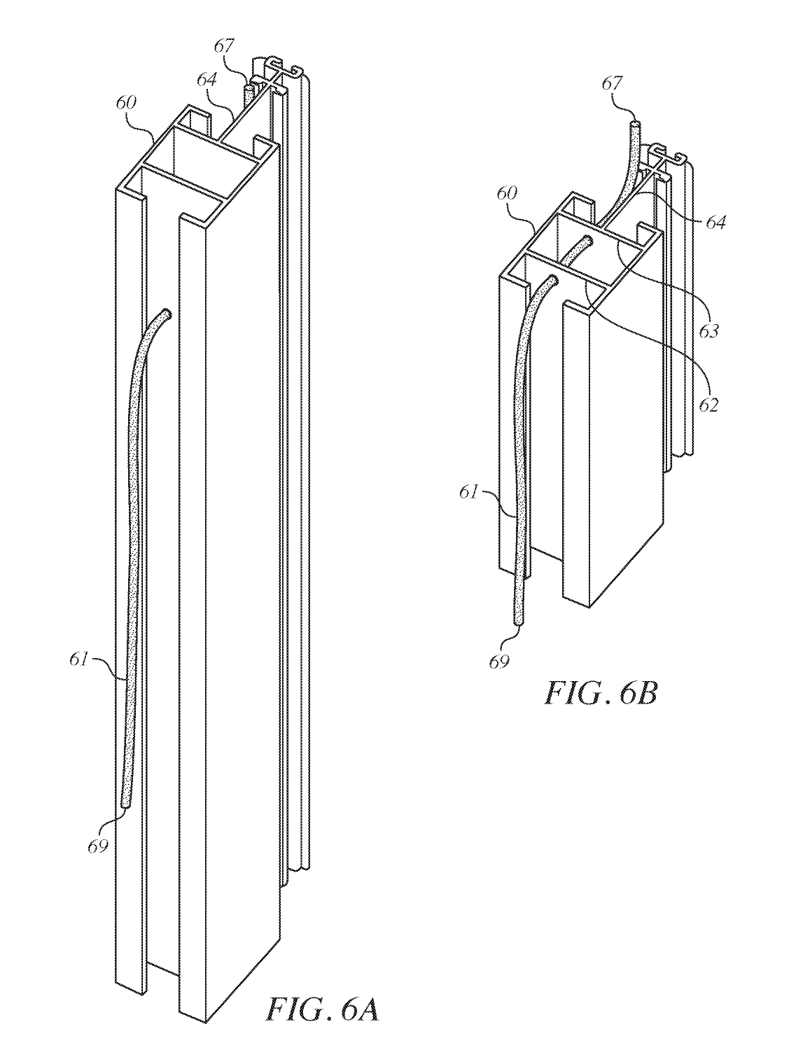

FIG. 6A shows an isometric fragmental view of a typical shop pre-wired and ready to be erected airloop mullion 60 of the present invention at a side edge solar panel. The mullion wire 61 is shop-installed inside the mullion 60 on one side of the mullion web 64 with one loose wire end 67 turning upwardly for field connection to the starting or ending solar panel on the side of each row of solar panels, and one loose wire end 69 for field connection to the starting solar panel at another row of solar panels or to the wiring system leading to the power distribution center of the building. As shown in the embodiment of FIG. 6A, the second loose wire end 69 turns downwardly for connection to a below row of solar panels. In other embodiments, the second loose wire end would turn upwardly for connection to an above row of solar panels. The length of the mullion wire 61 depends on the distance required for the field wire connections.

FIG. 6B is a cut away view of the mullion 60 near the mullion wire 61 inside the mullion 60 for the embodiment of FIG. 6A. The mullion wire 61 penetrates through two mullion walls 62 and 63 on one side of the mullion web 64.

FIG. 7 shows a fragmental isometric interior view of a left solar panel 70a and an adjacent right solar panel 70b, attached to a mullion 50 (looking from an angle from the bottom to show the underside of the head frame member 71a of the left solar panel 70a and the head frame member 71b of the right solar panel 70b). The preferred erection procedure for integrated solar energy unit wall panels of the present invention is: (1) Engage and secure the solar panels 70a and 70b to the mullion 50. (2) Pull down the loose end 51a of mullion wire 51 on the left side of the mullion web 54 and guide it through the wire hole 75a in head frame 71a. (3) Field-install a positive connector 58a on the mullion wire end 51a and connect positive connector 58a to the shop-installed negative connector 76a of solar panel 70a. (4) Pull down the loose end 51b of mullion wire 51 on the right side of the mullion web 54 and guide it through the wire hole 75b in head frame 71b. (5) Field-install a negative connector 59b on the mullion wire end 51b and connect negative connector 59b to the shop-installed positive connector 74b of solar panel 70b to complete the electrical connection between solar panels 70a and 70b. (6) Install glazing beads 74a and 74b onto the head frames 71a and 71b, respectively, to complete the air seal and hide the wiring system in panels 70a and 70b. (7) Snap on mullion cover 57 to hide the mullion wire 51 from the interior view.

Solar energy units may be replaced if damaged or dysfunctional, to upgrade to new solar energy technology, or for any other reason replacement is desired. Preferred embodiments of the present invention allow for easy replacement of solar energy units from the interior side of the building. With reference to the preferred embodiment wall panel 30 of FIG. 3, replacement of an insulated glass solar energy unit 10 may be accomplished by the following preferred steps: (1) Deglaze the panel 30 by removing the glazing beads 34 on all four sides of the solar energy unit 10. (2) Disconnect both connectors of the solar energy unit 10 from the respective mullion wire connectors and remove solar energy unit 10 from the panel frame. (3) Place a new solar energy unit into the panel frame and re-connect the wire connectors (no need to field install the connectors on the mullion wire because they are already in place). (4) Reinstall the glazing beads 34 on all four sides of the new solar energy unit to secure the new solar energy unit to the panel frame.

With reference to the preferred embodiment wall panel 40 of FIG. 4, the preferred procedure for replacing a single glass solar energy unit 20 are similar to the above steps, except the above steps (2) and (3) involve additional removal and replacement of the structural panel 46, which may be reused.

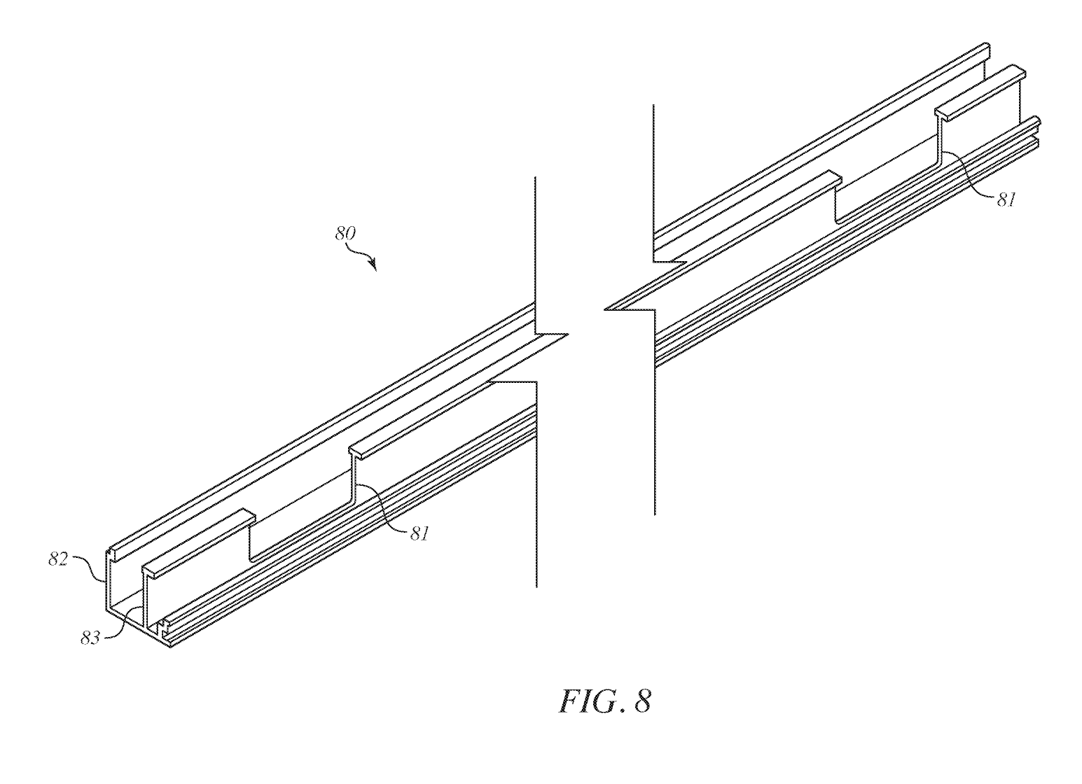

FIG. 8 shows a fragmental isometric view of a typical shop-fabricated head glazing bead 80 with notches 81 at the locations of wires and/or connectors. The head glazing bead 80 has two engaging legs 82 and 83. The leg 82 is exposed interiorly and within the air seal envelope. The size of the notches 81 on the leg 83 depends on the size of the interference caused by the wire and/or connectors. The leg 83 is hidden from interior view. Because the leg 83 is within the pressure equalized airloop, the notches 81 have no impact on the airloop curtain wall's watertightness performance.

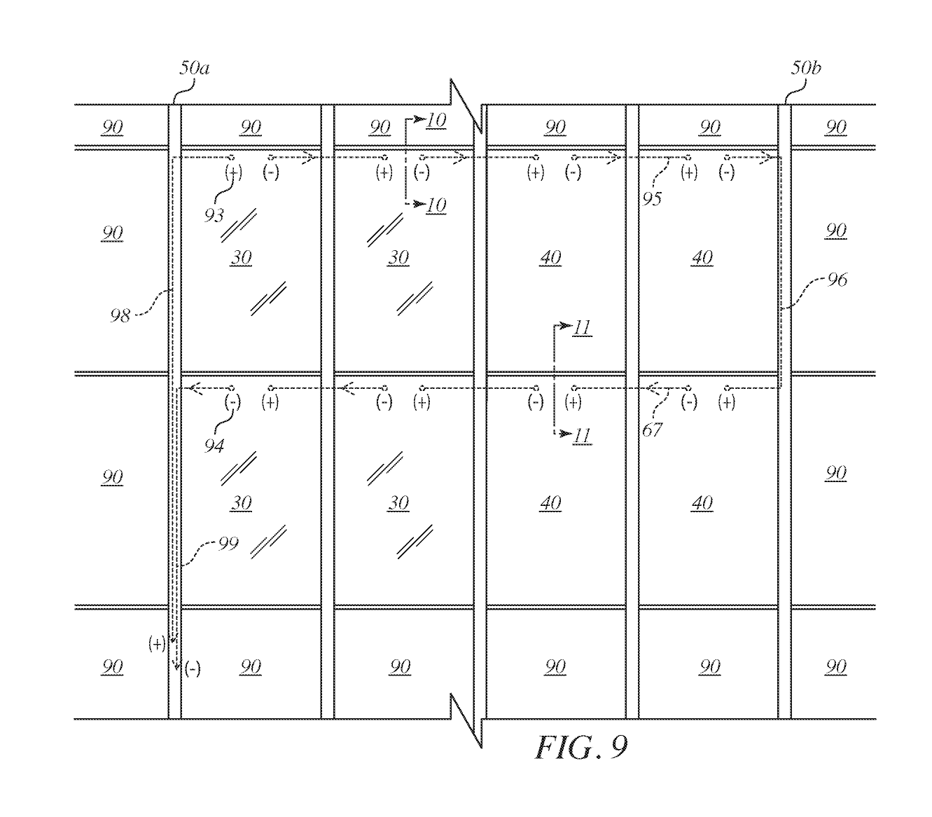

FIG. 9 shows as an example a partial interior view of an installed wall with solar panels showing no exposed wiring and a preferred wiring path for a concealed wiring system connected in series, as explained as follows: (1) The solar panel area consists of two rows of solar panels, each with two panels 30 with an insulated solar energy unit (as shown in FIG. 3) and two panels 40 with a single glass solar energy unit (as shown in FIG. 4). (2) The wiring starting point 93 is a positive port with a downward wire 98 inside a mullion 50a leading to a power distribution center (not shown). (3) Horizontal wiring path 95 connects the first row of two panels 30 and two panels 40 in series to reach another mullion 50b. (4) Continue the path of connection in series to a below row of panels with a downward wire 96 inside mullion 50b that turns into a second horizontal path 67 in the below row of solar panels to reach the final negative port 94 at the mullion 50a. (5) The downward wire 99 within the mullion 50a is connected to the final negative port 94 and leads to the power distribution center. In this arrangement, the final positive and negative wires are within the same mullion. This greatly simplifies wiring system management in the power distribution center. Step (4) above may be accomplished by alternating the orientation of the electrical ports from row to row. Additional rows of solar panels may be connected in the same manner. The area of solar panels may be randomly surrounded by compatible, non-solar airloop panels 90 of various facing materials without any interface performance problems.

FIG. 10 shows a fragmental cross-section taken along line 10-10 of FIG. 9, showing a horizontal panel joint formed by the engagement of an upper, regular, non-solar panel 90 and a lower insulated solar energy panel 30. Based on the above-referenced U.S. patents for the airloop system design, space 175 is the wet segment of the pressure equalized outer airloop and space 176 is the dry segment of the pressure equalized outer airloop. Air holes 177 in the sill frame member 133 of the non-solar panel 90 are provided to pressure equalize the inner airloop space 178. As one of ordinary skill in the art would recognize, inner airloop space 178, shown adjacent to the sill frame member 133 in FIG. 10, forms a pressure-equalized airloop around the perimeter frame of the panel 90 via corresponding, connected air spaces in the jamb frame members and head frame member of the panel 90.

Similarly, the inner airloop space 188 formed adjacent to the head frame member of the insulated solar energy panel 30 forms a pressure-equalized airloop around the perimeter frame of the panel 30 via corresponding, connected air spaces in the jamb frame members and sill frame member of the panel 30.

The hole 35 in the head frame member of the insulated solar energy panel 30 penetrated by the mullion wire 151 is between the dry outer airloop segment 176 and the top segment of the inner airloop 188 (all pressure equalized spaces); therefore, no air or water seal is required for hole 35. The connected wire connector assembly 191 (the connected positive and negative wire connectors of the solar energy unit and the mullion wire 151) is housed within the notched head glazing bead 180.

The only mullion wire holes subjected to differential air pressure are the wire holes penetrating through the mullion wall 53 as shown in FIGS. 5A and 5B. However, those wire holes are within the dry outer airloop segment. Therefore, even without any seal around those holes, there will be no water leakage. Since mullion wires through those holes may be pre-installed in the shop, hole caulking can be applied in the shop to eliminate concerns about the small amount of air leakage through the holes.

FIG. 11 shows a fragmental cross-section taken along line 11-11 of FIG. 9, showing a horizontal panel joint formed by the engagement of two identical panels 40 having single glass solar energy units. Most of the performance features are the same as explained for FIG. 10 above. Based on the above-referenced U.S. patents for the airloop system design, space 275 is the wet segment of the pressure equalized outer airloop and space 276 is the dry segment of the pressure equalized outer airloop. Air holes 277 on the sill frame member 43 are provided to pressure equalize the inner airloop space 278. As one of ordinary skill in the art would recognize, inner airloop space 278, shown in the sill frame member 43 in FIG. 11, forms a pressure-equalized airloop around the perimeter frame of the panel via corresponding, connected air spaces in the jamb frame members and head frame member of the panel.

The hole 45 in the head frame member penetrated by the mullion wire 251 is between the dry outer airloop segment 276 and the top segment of the inner airloop 288 (all pressure equalized spaces). Therefore, no air or water seal is required for hole 45. The connected wire connector assembly 291 (the connected positive and negative wire connectors of the solar energy unit and the mullion wire 251) is housed in the space between the end of the wire chase 22 and the end of the adjacent structural spacer block 23 (shown in FIGS. 2 and 4). The head glazing bead 280 is notched at the location of passage of the mullion wire 251.

The air space 298 between the single glass pane 21 and the structural panel 46 also is pressure-equalized due to the fact that air can freely enter the space 298 from the inner airloop space 288 through the gaps between the structural blocks 23 (shown in FIGS. 2 and 4). The static wind load on the single glass pane 21 is reduced to zero due to the pressure equalized space 298. Therefore, the single glass pane 21 can be designed based only on the dynamic wind load during the process of pressure equalization, which is commonly and conservatively assumed in the industry to be 50% of the static design wind load. This can have a significant impact on cost reduction because a thinner and/or larger surface area single glass pane 21 may be used compared to a non-pressure equalized system.

The details as shown and described for preferred embodiments are designed for interior access for wiring connections and unit replacement. If exterior access is preferred (such as in areas where wall panels are not easily accessible from the building interior), one of ordinary skill in the art could readily modify the above-described preferred embodiments to permit exterior access to the solar energy units.

Even though a typical airloop curtain wall unit is used in illustrating the present invention, some of the design features can be used in other conventional systems to improve their functional performance.

Nothing in the above description is meant to limit the present invention to any specific materials, geometry, or orientation of elements. Many modifications are contemplated within the scope of the present invention and will be apparent to those skilled in the art. The embodiments described herein were presented by way of example only and should not be used to limit the scope of the invention.

1. An integrated solar energy curtain wall system comprising:
a first airloop curtain wall panel comprising a first solar energy unit secured in a first perimeter frame,
a second airloop curtain wall panel comprising a second solar energy unit secured in a second perimeter frame,
a mullion between said first airloop curtain wall panel and said second airloop curtain wall panel,
a mullion wire passing through said first perimeter frame, said mullion, and said second perimeter frame to provide an electrical connection between said first solar energy unit and said second solar energy unit.

2. The curtain wall system of claim 1, wherein said first solar energy unit can be removed from said first perimeter frame from a building interior.

3. The curtain wall system of claim 1, wherein said first solar energy unit is an insulated glass solar energy unit.

4. The curtain wall system of claim 1, wherein said first solar energy unit is a single glass solar energy unit.

5. An integrated solar energy curtain wall system comprising:
a first airloop curtain wall panel comprising a first solar energy unit secured in a first perimeter frame,
a second airloop curtain wall panel comprising a second solar energy unit secured in a second perimeter frame, wherein said first perimeter frame and said second perimeter frame engage to form a horizontal joint,
a mullion engaged with said first airloop curtain wall panel and said second airloop curtain wall panel,
a mullion wire passing through said first perimeter frame, said mullion, and said second perimeter frame to provide an electrical connection between said first solar energy unit and said second solar energy unit.

6. The curtain wall system of claim 5, wherein said first solar energy unit can be removed from said first perimeter frame from a building interior.

7. The curtain wall system of claim 5, wherein said first solar energy unit is an insulated glass solar energy unit.

8. The curtain wall system of claim 5, wherein said first solar energy unit is a single glass solar energy unit.
